(19) United States
(12) Patent Application Publication
(10) Pub. No.: US 2008/0179326 A1
(43) Pub. Date: Jul. 31, 2008

(54) Push Button Dispensing Lid

(76) Inventors: Marlene N. Krauth, Rogers, AR (US); Peter Piscopo, Medford, NJ (US); Richard Seager, Mystic, CT (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/948,010

(22) Filed: Nov. 30, 2007

Related U.S. Application Data
(63) Continuation-in-part of application No. 11/565,114, filed on Nov. 30, 2006.

(51) Int. Cl. B65D 51/00; G07F 11/00

(52) U.S. Cl. 220/260; 221/154

(57) ABSTRACT

A sealing push-button lid for consumer wipes is disclosed. The lid may be used to seal a package of wipes for infant care, and may also be used for sealing and dispensing of one-at-a-time wipes for general cleaning purposes. The push button dispensing lid preferably has a top and a bottom of unitary construction joined together with an integral, springless hinge.

This patent application is a continuation-in-part of copending U.S. patent application Ser. No. 11/565,114, filed on Nov. 30, 2006, entitled “Push Button Dispensing Lid,” which patent application is assigned to the assignee of the present invention, and which patent application is hereby incorporated herein by reference in its entirety.

### BACKGROUND OF THE INVENTION

### Field of the Invention

This invention generally relates to sealing lids for dispensing of one-at-a-time wipes for consumer healthcare, infant care, cleaning and wiping products.

Busy families on the go prefer to take their children on family expeditions of all types, whether traveling to relatives, other parts of their country, or even foreign countries. When traveling with children, it is highly convenient to include wetted disposable tissues or wipes for cleaning and sanitation purposes. These wipes may include baby wipes, kitchen wipes, or general-purpose cleaning wipes. Packages of such wipes should be small and convenient for packing and travel. In addition, packs of the wipes should be flexible and able to fit into a small space within a travel bag or suitcase. Thus, a flexible container in a soft-pack is preferable to a larger pack with a hard plastic cylinder or rounded rectangular tub. These large, hard packages will not fit conveniently into consumers' travel plans or for consumers with limited space available.

Of course, it goes without saying that the package of wipes, once opened, should be able to retain its moisture, and thus its cleaning ability, as well as the lotions, scents, or other products that are incorporated into the wetted wipes. A large package with 200-300 wipes can more easily bear the cost of a reliable and expensive closure that includes a good moisture seal. A small flexible package of wipes will only be practical if the opening or seal of the package is both inexpensive and effective. The prior art shows many attempts at such seals. For example, U.S. Pat. No. 6,206,221 discloses a covering plate with a hinged lid for applying to a large container of wetted tissues or wipes. The cover includes a top plate and a hinged lid, and the cover extends to enclose a top of an entire container of wipes. This product is complicated, and will be too expensive and heavy for the use that is desired. U.S. Pat. No. 6,394,298 is similar to the '221 patent, in that the dispensing cover disclosed is designed to fit over an entire, large container. This cover will also be heavy and inconvenient.

U.S. Pat. No. 6,655,544 may be even further from the mark, disclosing an entire container with a lid. The container and lid include a fairly complicated sealing and locking mechanism. Products made in accordance with this disclosure will seal well, but will not be flexible or convenient for travel and quick access to the wetted wipes. U.S. Pat. No. 6,729,498 has a similar disclosure, with a dispenser having a container and a lid. This dispenser will also be relatively expensive and rigid, as opposed to the desired flexible and inexpensive lids sought by consumers. U.S. Pat. No. 6,902,077 and U.S. Pat. No. 7,021,483 are similar, disclosing a rigid, heavy container for wetted wipes. These patents include a complicated hinging mechanism, and include ribs for additional stability and rigidity, rather than the desired flexibility.

U.S. Pat. No. 7,004,349 discloses another relatively rigid container and lid with an elastomeric spring to help pop open the lid when a user depresses a latch. U.S. Pat. No. 6,942,118 teaches a closure for a container, rather than an entire container and closure, per the discussions above. However, while wetted wipes or cloths are discussed, there is no provision for a seal between the closure and the container to which it will be fitted, except for a tight fit between the two. This may be achieved by using dimensions with tight tolerances for fitting the closure onto the container. The closure will thus be both relatively expensive and relatively rigid.

As noted above, the prior art discloses rigid containers and relatively rigid and complicated seals for those containers, but does not teach a cover only, the cover relatively flexible and sufficiently simple to be cost effective in today's competitive, cost-conscious markets. The present invention provides such a simple, flexible, and easy-to-open cover. These and other advantages, as well as additional inventive features, will be apparent from the description of the embodiments provided herein.

### SUMMARY OF THE INVENTION

The disadvantages and limitations of the background art discussed above are overcome by the present invention. With this invention, a push button dispensing lid is provided for preferable use in combination with a soft-pack of wetted wipes, wetted tissues, wet cleaning cloths, or other wetted disposables in which a resealable lid configured to retain moisture easily within the pack is desired. The push button lid of the present invention is configured to provide easy access to the underlying pack while providing a closure and seal to keep the moist towels or cleansing cloths within the pack moist and hydrated, without undesirable loss of moisture.

The push button dispensing lid includes a lid top pivotally engaged to a lid bottom at their respective rear ends. The lid top and lid bottom are engaged by a hinge, integrally formed with the lid top and lid bottom, so that the lid may be formed of a single piece of material. Preferably, the lid includes a cam action hinge, such that when closed the hinge is under tension, and release of the front edge of the lid top from the lid bottom causes the lid top to automatically pivot to an open position.

Certain preferred embodiments of the present invention are made by injection molding the lids in a single or unitary construction using a polypropylene resin to take advantage of the inherent “living hinge” that is possible with polypropylene. Lid embodiments according to the present invention may also be made with other preferably flexible resins, such as polyethylene, low density polyethylene, or linear low density polyethylene. Henceforth, the term polyethylene is intended to include standard polyethylene, low density polyethylene, and linear low density polyethylene. Other resins may include polycarbonate, acrylonitrile-butadiene-styrene (ABS), acetal, and nylon. While injection molding is a preferred low-cost, high volume method of production, the lids may also be made by thermoforming, or any other suitable method of production.

The lid of the present invention includes a lid bottom having a push button that extends away from and is configured to be spaced apart from the front edge of the lid bottom. The push button includes a latching mechanism configured to removably engage the lid top. Importantly, the push button is provided with a degree of flexure, so that the push button can be depressed and deflected with respect to the lid bottom, providing the lid with a first latched position, wherein the push button latching mechanism engages and retains the lid top closed, and a second open position, wherein the push button latching mechanism releases the lid top and pivots away from the lid bottom. The connection between the push button and the lid bottom is provided with enough flexibility or flexure to permit release of the lid top from the latching mechanism, but does not permit the seal between the lid and the package to be disturbed or broken.

The rear edge of the lid bottom preferably includes an integrally formed hook, provided to engage a tension member to assist in opening the lid. The lid top is biased away from the lid bottom about the integral hinges. The lid top includes a latching mechanism at its front end that is configured to releasably engage the lid bottom when the lid is closed. As such, the lid top preferably has a catch for mating with the latching portion of the lid bottom, and, as described herein, the lid top is hingedly and flexibly connected to the lid bottom via the integral hinges.

The push button dispensing lid of the present invention will also work well when used with more traditional, harder containers, such as stiff cylindrical or roughly-rectangular or roughly square plastic or fiber-board containers. Consistent with the broader aspects of the present invention, other types of containers and/or container applications that include wetted materials other than wipes can incorporate the push button dispensing lid of the present invention with good effect.

The apparatus of the present invention is of a construction which is both durable and long lasting, and which will require little or no maintenance to be provided by the user throughout its operating lifetime. The apparatus of the present invention is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

The accompanying drawings incorporated in and forming a part of the specification illustrate several embodiments of the present invention and, together with the description, serve to explain the principles of the invention. In the drawings:

FIG. 1 is a is a perspective view of a first embodiment push button dispensing lid according to the present invention, shown attached to a pack in a closed position;

FIG. 2 is a is a perspective view of the push button dispensing lid illustrated in FIG. 1, shown in an open position;

FIG. 3 is a is a top view of the push button dispensing lid illustrated in FIGS. 1 to 2, shown in a closed position;

FIG. 4 is a is a top view of the push button dispensing lid illustrated in FIGS. 1 through 3, shown in an open opinion;

FIG. 5 is a is partial top view of a lid bottom and push button of the push button dispensing lid illustrated in FIGS. 1 through 4;

FIG. 6 is a sectional view of the push button dispensing lid illustrated in FIGS. 1 through 5, taken along the line 6-6 in FIG. 3, showing the push button in a latched position;

FIG. 7 is a sectional view of the push button dispensing lid illustrated in FIG. 6, showing the push button in an unlatched position;

FIG. 8 is a sectional view of the push button dispensing lid illustrated in FIGS. 6 and 7, showing the lid top biased away from the lid bottom;

FIG. 9 is a sectional view of the push button dispensing lid illustrated in FIGS. 1 through 8, taken along the line 9-9 in FIG. 3, showing the lid in its closed position and the spring in its energized position; and

FIG. 10 is a sectional view of the push button dispensing lid illustrated in FIG. 1 through 8, taken along the line 10-10 in FIG. 4, showing the lid in its closed position and the spring in its energized position.

FIG. 11 is a perspective view of a second embodiment push button dispensing lid according to the present invention, shown attached to a pack in a closed position;

FIG. 12 is a perspective view of the push button dispensing lid illustrated in FIG. 11, shown in an open position;

FIG. 13 is a partial side view of the push button dispensing lid illustrated in FIGS. 11 and 12, shown in an open position;

FIG. 14 is a is a sectional view of the push button dispensing lid illustrated in FIGS. 11 through 13, taken along the line 12-12 in FIG. 11, showing the cam action hinge;

FIG. 15 is a partial side view of the push button dispensing lid illustrated in FIGS. 11 through 14, shown in an open position;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PREFERRED EMBODIMENT

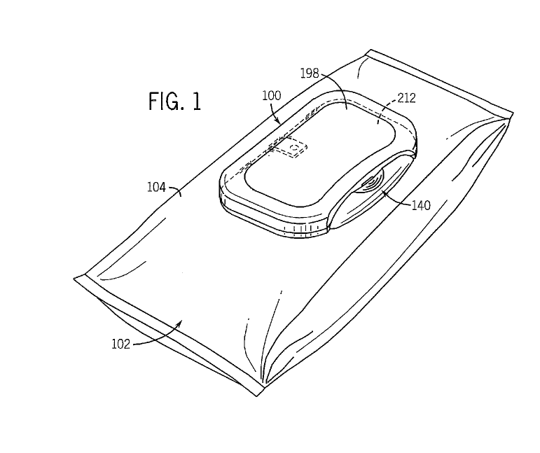

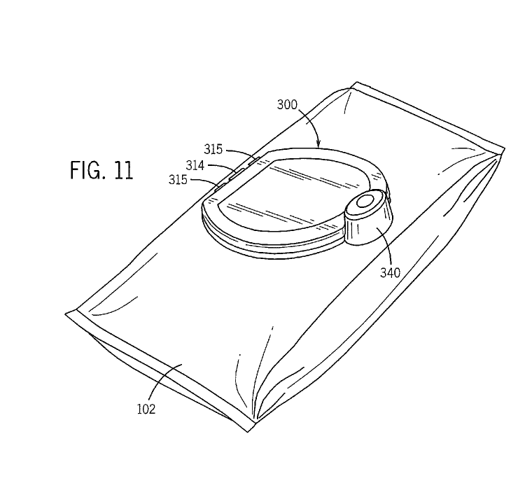

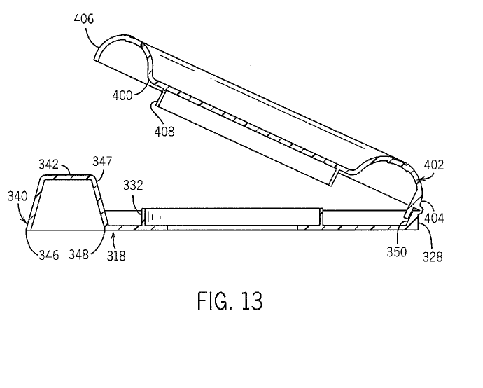

A first embodiment of a push button dispensing lid 100 in accordance with the teachings of the present invention is illustrated in FIGS. 1 through 10. Another embodiment of a push button dispensing lid 300 is illustrated in FIGS. 11 through 15. It will be appreciated that the embodiments described herein are desirably used in combination with a soft-pack of wetted wipes, wetted tissues, wet cleaning cloths, or other wetted disposables. The push button dispensing lid has been designed to fit onto a top surface of a flexible soft-pack of wipes. The lid allows the user to open the underlying pack while providing a closure and seal to keep the moist towels or cleansing cloths within the pack moist and hydrated, without undesirable loss of moisture. Embodiments may include a convenient quantity of Z-folded wipes or inner-folded wipes in a preferably soft and flexible container. Containers with the push button lid may also be used with wipes that are folded in other ways. The pack or container can be somewhat small, to fit into a handbag or travel bag for convenience on the move. Such packs are typically made from one or more layers of plastic film, such as polyethylene film, polypropylene film, polyester or Tyvek film, and the like.

The lid will also work well when used with more traditional, harder containers, such as stiff cylindrical or roughly-rectangular or roughly square plastic or fiber-board containers. Consistent with the broader aspects of the present invention, other types of containers and/or container applications that include wetted materials other than wipes can incorporate the push button dispensing lid of the present invention with good effect.

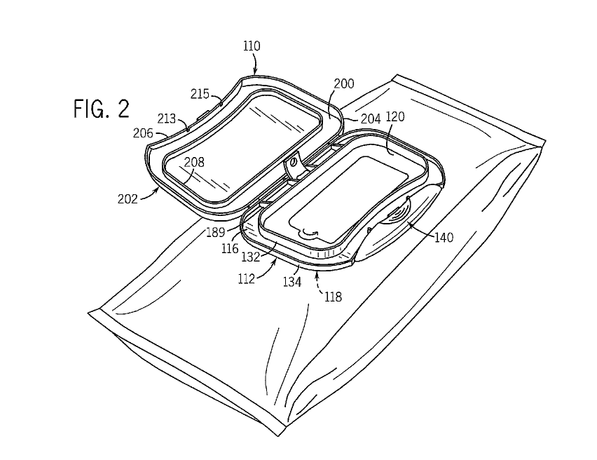

Turning now to FIGS. 1 and 2, the push button dispensing lid 100 of the present invention is illustrated atop a tissue pack 102. In certain preferred embodiments of the present invention, the pack 102 is constructed of one or more layers of thin, flexible film and includes a top surface 104 having an opening 106 for dispensing a plurality of tissues or wipes (not illustrated). The size and shape of the opening 106 is sufficient to allow the wipes to be easily removed but is not so large as to permit unwanted moisture from escaping the package.

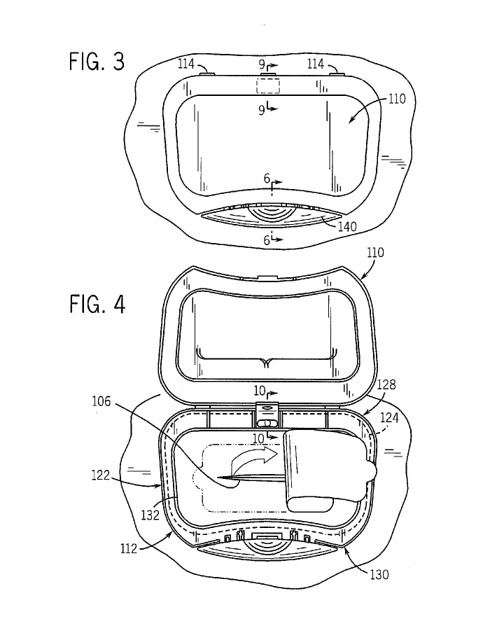

Turning next to FIGS. 3 and 4, in addition to FIGS. 1 an 2, the lid 100 has a lid top 110, a lid bottom 112 and flexible, hinges 114 connecting the lid top 110 and the lid bottom 112. The lid 100 is preferably of unitary construction, such that each of the hinges 114 are integrally formed with and connect the lid top 110 and the lid bottom 112. Thus, the lid 100 can be manufactured of a single piece of material. Forming the lid 100 in this way, provides the lid 100 with living hinges, or a flexure point having no moving parts, allowing the lid top 110 to pivot about the hinges 114 and away from the lid bottom 114. It will be appreciated that elimination of moving parts from the lid 100, renders the lid easy to manufacture and assemble, provides the lid excellent fatigue resistance and helps to maintain the lid together, versus a hinge mechanism containing components that may break or become separated from either the lid top or the lid bottom. The hinges 114 are preferably about one-quarter inch (about 6 mm) wide, and are about 0.040 inches (about 1 mm) thick. There are preferably two or three spaced-apart hinges between the lid top and bottom, although more hinges or less hinges can be used, depending on end-use application of the lid 100.

The lid bottom 112 has a top surface 116 configured to engage the lid top 110, a bottom sealing surface 118, an outer edge, indicated generally at 122, surrounding the perimeter of the lid bottom 112 and a central aperture or void area 120, which will allow a user to dispense the product from the pack 102 when the lid 100 is opened. The outer edge portion 122 includes a rear side, indicated generally at 128 and a front side, indicated generally at 130.

The bottom sealing surface 118 is preferably secured to the top surface 104 of the pack 102 so that the central void area 120 of the lid 100 encompasses the opening 106. The lid 100 is configured to be secured around a portion of the top surface 104 of the pack 102, rather than encompassing the entire top surface 104 of the pack 102. The bottom sealing surface 118 is mated to the top surface 104 of the pack 102 of wipes with a bead of hot melt glue 124 on either the bottom sealing surface 118 of the lid bottom 112 or the top surface 104 of the pack to provide a substantially impermeable seal between the pack 102 and the lid 100. However, the lid 100 can be secured to the pack 102 by other means known to those skilled in the art, such as using strips of adhesive or ultrasonic welding.

A sealing flange or inner wall 132 surrounds the void area 120 and extends upwardly from the bottom sealing surface 118 of the lid bottom 112. An outer wall 134 also extends upwardly from the bottom sealing surface 118; however, a portion 135 near the front side 130 of the outer edge 122 of the lid bottom 112 is not encompassed by the outer wall 134. The inner wall 132 is preferably taller than the outer wall 134, for example, about one-quarter inch, or 6-7, mm high, while the wall 134 is about one-eighth inch high, or about 3 mm high, or a little less. As illustrated in FIG. 2, the hinge 114 is provided near the top of the outer wall 134 on the rear side 128 of the lid bottom 112.

The lid bottom 112 comprises latch, such as a push button, 140 that extends away from the front side 130 of the outer edge 122 and is spaced apart therefrom. The push button 140 is illustrated in the form of an upside-down canoe, i.e. the push button is hollow, having a closed top surface 142, an open underside 144, a front edge, indicated generally at 146, and a rear edge, indicated generally at 148. The top surface 142 of the push button 140 can include a gripping area 150 for accommodating a thumb or finger of a user. As illustrated in FIGS. 3 through 5, a catch 153 configured to engage the lid top 110 is provided on the rear edge 148 of the push button 140. Consistent with the broader aspects of the present invention, it will be appreciated that the push button 140 may be configured in a number of different shapes and sizes.

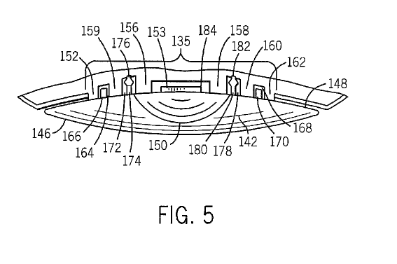

As best illustrated in FIG. 5, a plurality of connectors or ribs 152, 154, 156, 158, 160 and 162 extend from the portion 135 of the outer edge 122 of the lid bottom 112 and connect the push button 140 thereto. An aperture 164 is located in between ribs 152 and 154 and a thin guide or extension 166 projects partially into the aperture 164 from the rear edge 140 of the push button 140. Likewise, an aperture 168 is located in between ribs 160 and 162 and a thin guide or extension 170 projects partially into the aperture 168 from the rear edge 140 of the push button 140.

An aperture 172 is located in between ribs 154 and 156. At substantially the midpoint of the aperture 172, an L-shaped arm 174 connects the front edge 130 of the lid bottom 112 to the rear edge 148 of the push button 140. The arm 174 includes a latching protrusion or projection 176 configured to mate with and secure the lid top 110 in position, as described herein. Likewise, an aperture 178 is located in between ribs 158 and 160. At substantially the midpoint of the aperture 178, an L-shaped arm 180 connects the front edge 130 of the lid bottom 112 to the rear edge 148 of the push button 140. The arm 180 includes a latching protrusion or projection 182 configured to mate with and secure the lid top 110 in position, as described herein. A larger aperture 184 separates the ribs 156 and 158.

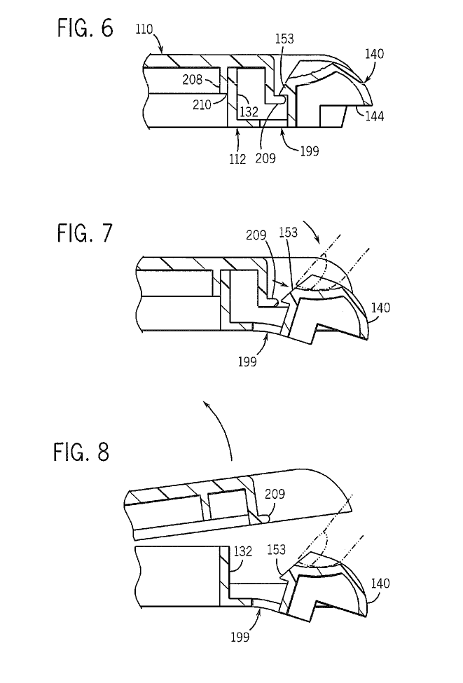

Without regard to any particular theory or mode of operation, it will be appreciated that the combination of extension ribs 152, 154, 156, 158, 160 and 162 and apertures 164 168, 172, 178 and 182 provide the push button 140 with flexibility and/or a flexible portion (indicated at 199), such that the push button 140 can be depressed and deflected with respect to the lid bottom 112, as best illustrated in FIGS. 6 through 8. This provides the lid 100 with a first latched position, as illustrated in FIG. 1, to a second open position, as illustrated in FIG. 2, without disturbing or breaking the seal between the lid bottom 112 and the top 104 of the pack 102.

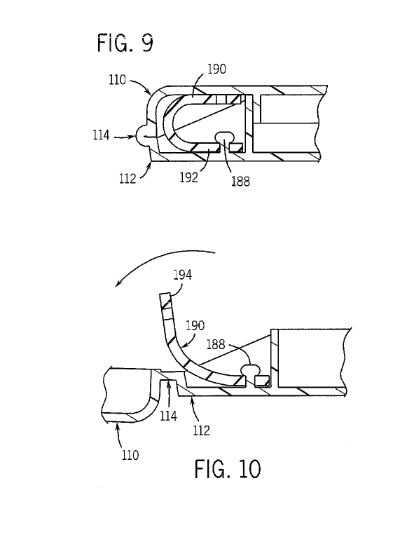

The lid bottom 112 also includes a hook 188, located adjacent to the hinge 114, which extends upwardly from the top surface 116 thereof, near the rear side 128 of the outer edge 122. The hook 188 is preferably integrally formed in the lid bottom 112. A tension member 190 is configured to engage the hook 188. In this embodiment, the tension member 190 is formed by a rectangle of flexible rubber or plastic and secured by its near end 192 to the hook 188. As illustrated in FIGS. 9 and 10, the far end 194 of the tension member 190 bears against the lid top 110 to urge apart the lid top 110 and bottom 112 when the user pushes the push button 140 to open the lid 100. It will be appreciated that the hook 188 and the tension member 190 can be provided on the lid top 110 as well. The top surface 116 of the lid bottom 112 can also be provided with additional ribs 189, which extend from the inner wall 132 to the outer wall 134 to add some rigidity to the hinged portion of the lid bottom 112.

The lid top 110 includes a top surface 198, a bottom surface 200 and an outer edge, indicated generally at 202, surrounding the perimeter of the lid top 110. The outer edge portion 202 includes a rear side, indicated generally at 204 and a front side, indicated generally at 206.

The bottom surface 200 of the lid top 110 has a sealing flange or inner wall 208 extending downwardly therefrom which is configured to fit with and sealing mate with the inner wall 132 of the lid bottom 112. As illustrated in FIG. 6, this is preferably the principle seal 210 between the lid top 110 and the lid bottom 112. A space 212 within the sealed area provides room for the tail end of the next wipe or towelette to be dispensed from the pack 102.

The outer edge 202 forms a downwardly extending outer wall of the lid top 110 and is configured to engage and mate with the outer wall 134 of the lid bottom 112. The rear side 204 of the outer edge 202 is pivotally engaged to the lid bottom 112 by the hinge 114. The front side 206 includes a catch 209 extending outwardly therefrom, which is configured to functionally engage the catch 153 on the push button 140. The catch 209 preferably extends about the same as catch 153, about 040 to 0.060 inches, about 1 mm. Other dimensions may also be used. Each of the catches may range from about one-quarter inch (about 6 mm) to about one-half inch (about 13 mm) wide, preferably about three-eighths of an inch (about 10 mm) wide. Notches 213 and 215 are also provided on the front side 206 of the lid top 110. Each of the notches 213 and 215 are sized so that the latching projections 176 and 182 of arms 174 and 180, respectively, fit therein

It may therefore be appreciated from the above detailed description of the preferred embodiment of the present invention that once installed on the package 102, the lid 100 provides a resealable closure to the pack 102 of wipes to retain moisture therein. It will be appreciated that in the closed position, the catch 153 of the lid bottom 112 overlies and retains the catch 209 of the lid top 110. Further, in the closed position, the latching projections 176 and 182 of the arms 174 and 180, respectively, on the push button 140 fit with the notches 213 and 215 on the lid top 110. To retain moisture, the inner wall 208 of the lid top 110 sealing engages the inner wall 132 of the lid bottom 112. While the lid 100 is closed, the tension member 190 is in its flexed or loaded position.

When it is desired to open the pack 102, the push button 140 is depressed. This action causes the push button 140 to flex somewhat away from the lid bottom 112 about the ribs 152, 154, 156, 158, 160 and 162. At this time, the catch 153 is pulled away from engagement with the catch 209. In addition, the arms 174 and 180 on the push button 140 also flex and the latching projections 176 and 182 disengage from the notches 213 and 215, respectively. Once disengaged, the tension member 190 biases the lid top 110 away from the lid bottom 112 and the lid 100 opens. The lid 100 can be closed after use by moving the lid top 110 into engagement with the lid bottom 112.

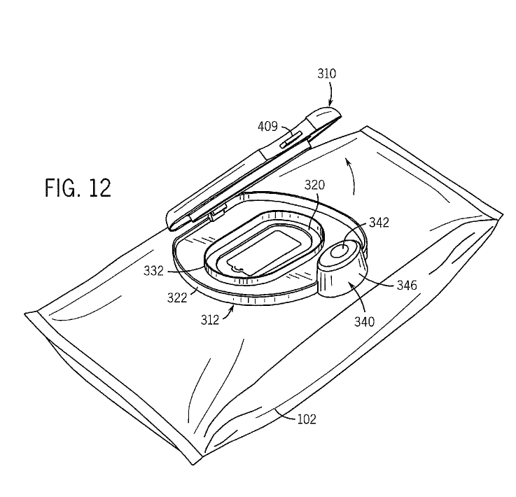

Turning next to FIGS. 11 through 15, the push button dispensing lid 300 embodied by the present invention is illustrated. Like the lid 100, FIGS. 11 and 12, illustrate the push button dispensing lid 300 atop the tissue pack 102. The lid 300 is constructed of a single piece of material and has a lid top 310 and a lid bottom 312 connected to each other by at least one cam action hinge 314 and at least one pivot 315. Each of the hinges 314 and the pivots 315 are integrally formed with and connect the lid top 310 and the lid bottom 312 together. It will be appreciated that elimination of moving parts from the lid 300, renders the lid easy to manufacture and assemble, provides the lid excellent fatigue resistance and helps to maintain the lid together, versus a spring loaded hinge mechanism containing components that may break or become separated from either the lid top or the lid bottom.

The lid bottom 312 is configured in a similar manner to the lid bottom 112, having a top surface 316 configured to engage the lid top 310 and a bottom surface 318 configured to be sealed to the top surface of the top surface 104 of the pack 102 to provide a substantially impermeable seal between the pack 102 and the lid 300. The lid 300 may be sealed to the pack 102 with adhesive (not illustrated) or by any means known to those skilled in the art.

The lid bottom 312 has an outer edge, indicated generally at 322, surrounding the perimeter of the lid bottom 312 and a central aperture or void area 320, which will allow a user to dispense the product from the pack 102 when the lid 300 is opened. The outer edge portion 322 includes a rear side, indicated generally at 328 and a front side, indicated generally at 330.

A sealing flange or inner wall 332 surrounds the void area 320 and extends upwardly from the bottom surface 318 of the lid bottom 312. An outer wall 334 also extends upwardly from the bottom surface 318; however, a portion near the front side 330 of the outer edge 322 of the lid bottom 312 is not encompassed by the outer wall 334. The inner wall 332 is preferably taller than the outer wall 334, for example, about one-quarter inch, or 6-7, mm high, while the wall 334 is about one-eighth inch high, or about 3 mm high, or a little less.

The lid bottom 312 comprises a closure mechanism, such as a push button, 340 that extends away from the front side 330 of the outer edge 322 and is spaced apart therefrom. The push button 340 may be any type of push button known to those skilled in the art that is capable of releasably latching the lid top and the lid bottom. For example, the push button element 340 may be configured similarly to the push button 140, as described with reference to the push button lid 100 above.

Alternatively, as illustrated in FIGS. 11-15, the push button 340 can be hollow, having a closed top surface, an open underside, a front edge, indicated generally at 346, and a rear edge, indicated generally at 348. The rear edge includes a catch 347 for engaging the lid top 310. Preferably, the push button 340 includes a flexible, compressible top portion 342 sized to accommodate a user's finger.

The lid top 310 includes a top surface 398, a bottom surface 400 and an outer edge, indicated generally at 402, surrounding the perimeter of the lid top 310. The outer edge portion 402 includes a rear side, indicated generally at 404 and a front side, indicated generally at 406. The outer edge 402 forms a downwardly extending outer wall of the lid top 310 and is configured to engage the outer wall 334 of the lid bottom 312. A sealing flange or inner wall 408 extends downwardly from the bottom surface 400 of the lid top 310 and is configured to fit with and sealing mate with the inner wall 332 of the lid bottom 312. The front side 406 of the lid top 310 includes lip or tab 409 that is configured to engage the catch 347 on the push button 340 on the lid bottom 312.

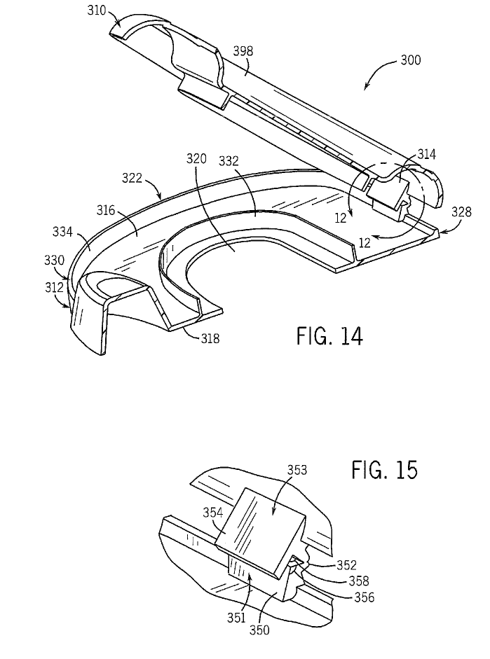

As best illustrated in FIGS. 14 and 15, the rear side 328 of the lid bottom 312 and the rear side 404 of the lid top 310 are joined together by the cam action hinge 314. The hinge 314 comprises a bottom piece 351 having a mating surface 350 which inclines upwardly and outwardly from the top surface 330 of the lid bottom 312, ending at a hinge connection point 352. The hinge 314 also comprises a top piece 353 including a substantially straight mating surface 354 that extends downwardly from rear side 404 of the lid top 310. The top piece 353 of the hinge 314 also includes an outwardly extending portion that terminates at the hinge connection point 352, joining the top piece 353 to the bottom piece 351. It will be appreciated that the mating surface 350 of the bottom piece 351 is formed at an angle 356 that is larger than the angle 358 of the mating surface 354 of the top piece 353 so that the lid top is lifted by cam action when the push button 340 is depressed. For example, when the lid 300 is closed, the top piece 353 and the bottom piece 351 of the hinge 314 fit together but are under tension in a flexed or loaded position. When the push button 340 is depressed, the lid top 340 is automatically pivoted away from the lid bottom.

It may therefore be appreciated from the above detailed description of the present invention that once installed on the package 102, the lid 300 provides a resealable closure to the pack 102 of wipes to retain moisture therein. To use the lid 300, the user depresses the flexible top portion 342 which causes the catch 347 to disengage from the tab 409 on the lid top. When it is disengaged, the cam action hinge 314, under pressure, is released and the lid 300 automatically opens. When it is desired to close the lid 300, the lid top 310 is moved downwardly until the tab 409 is again engaged with and held in place by the catch 347. The lid 300 does not require any moving parts, or the addition of a spring element to urge the lid open. Rather, the configuration of the integral cam action hinge 314 with the lid top 310 and the lid bottom 312 causes this action to occur immediately upon release of the front side 406 of the lid top 310 by the push button mechanism 340.

As described elsewhere herein, certain preferred embodiments of the present invention are made by injection molding the lids in a single or unitary construction using a polypropylene resin to take advantage of the inherent “living hinge” that is possible with polypropylene. Lid embodiments according to the present invention may also be made with other preferably flexible resins, such as polyethylene, low density polyethylene, or linear low density polyethylene. Henceforth, the term polyethylene is intended to include standard polyethylene, low density polyethylene, and linear low density polyethylene. Other resins may include polycarbonate, acrylonitrile-butadiene-styrene (ABS), acetal, and nylon. While injection molding is a preferred low-cost, high volume method of production, the lids may also be made by thermoforming, or any other suitable method of production.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A push button dispensing lid having an open position and a closed position, the lid comprising:
a lid bottom including a top surface, a bottom surface, a front edge, a rear edge and a dispensing aperture formed therethrough, the lid bottom including a latching mechanism extending from the front edge thereof;
at least one hinge integrally formed at the rear edge of the lid bottom; and
a lid top having a top surface, a bottom surface, a front edge, and a rear edge, the lid top pivotally and integrally secured at its rear edge to the lid bottom by the at least one hinge and having a latching mechanism at its front edge configured to engage the latching mechanism of the lid bottom when the lid is in its closed position.

2. The push button dispensing lid of claim 1, wherein the top surface of the lid bottom includes a wall surrounding the dispensing aperture that extends upwardly therefrom and wherein the bottom surface of the lid top includes a wall that extends downwardly therefrom, wherein wall extending from the lid top is sized to fit within and sealingly mate with the wall extending upwardly from the lid bottom.

3. The push button dispensing lid of claim 1, wherein the latching mechanism of the lid bottom comprises a push button integrally formed at the front edge of the lid bottom.

4. The push button dispensing lid of claim 3, wherein a plurality of integrally formed ribs connects the push button to the lid bottom, the ribs sized to permit the push button to flex between a first latched position and a second unlatched position.

5. The push button dispensing lid of claim 3, wherein the push button comprises at least one arm having a protrusion configured to engage the latching mechanism of the lid top when the lid is in its closed position.

6. The push button dispensing lid of claim 5, wherein the latching mechanism of the lid top comprises at least one notch sized to accommodate and releasably retain the at least one arm.

7. The push button dispensing lid of claim 3, wherein the push button further comprises a catch configured to engage the latching mechanism of the lid top when the lid is in its closed position.

8. The push button dispensing lid of claim 7, wherein the latching mechanism of the lid top further comprises a catch configured to engage the catch of the lid bottom when the lid is in its closed position.

9. The push button dispensing lid of claim 1, wherein the hinge is a cam action hinge comprising a first piece having a surface disposed at a first angle and secured to the lid top and a second piece having a second surface disposed at a second angle secured to the lid bottom, wherein the second angle is larger than the first angle and wherein the first and second surfaces fit together under pressure when the lid is in the closed position.

10. The push button dispensing lid of claim 1, further comprising a tension member secured at the rear edge of one of the lid bottom and the lid top, the tension member configured to pivot front edge of the lid top away from the front edge of the lid bottom when the latching mechanism on the lid top is disengaged from the latching mechanism of the lid bottom.

11. The push button dispensing lid of claim 10, wherein the tension member is a compressible spring element secured to the rear edge of the lid bottom.

12. A springless, push button dispensing lid for secured attachment to a package containing a wetted product, the lid comprising:
a lid bottom having a top, a bottom, a rear edge portion and a front edge portion, the lid bottom also having a dispensing aperture formed therein and a sealing flange extending up from the top of the lid bottom and encompassing the dispensing aperture;
a lid top having a top surface, a bottom surface, a front edge portion, a rear edge portion and a sealing flange extending down from the bottom of the lid top and configured to mate with the sealing flange of the lid bottom, wherein the rear edge portion of the lid top is formed integrally with and pivotally secured to the rear edge portion of the lid bottom; and
a push button flexibly secured and integrally formed with the front edge portion of the lid bottom, the push button including a latching portion configured to engage the front edge portion of the lid top.

13. The push button dispensing lid of claim 12, wherein the lid bottom and the lid top are formed of a single piece of material and are joined by at least one living hinge.

14. The push button dispensing lid of claim 13, wherein the living hinge is a cam action hinge comprising a first piece having a surface disposed at a first angle and secured to the lid top and a second piece having a second surface disposed at a second angle secured to the lid bottom, wherein the second angle is larger than the first angle and wherein the first and second surfaces fit together under pressure when the lid is in the closed position.

15. The push button dispensing lid of claim 13, wherein the material is polypropylene.

16. The push button dispensing lid of claim 12, wherein sealing flange of the lid bottom and the sealing flange of the lid top form at least one seal around the dispensing aperture and also provide an open space to accommodate product.

17. The push button dispensing lid of claim 12, wherein the front edge portion of the lid top comprises an outwardly extending catch and at least one notch.

18. The push button dispensing lid of claim 17, wherein the latching portion of the push button includes a catch aligned with and configured to engage the catch on the lid top and at least one arm size to removably fit within the at least one notch on the lid top, the push button having a first, latched position wherein the catch of the push button retains the catch of the lid top and wherein the arms of the push button are positioned within the notches, and a second, released position, wherein each of the catch and the arms on the push button are flexed away from and out of contact with the catch and notches of the lid top.

19. The push button dispensing lid of claim 12, wherein the push button further comprises a gripping portion for a thumb or a finger of a user.

20. A springless, push button dispensing lid for secured attachment to a package containing a wetted product, the lid comprising:
a lid bottom having a top, a bottom, a rear edge portion and a front edge portion, the lid bottom also having a dispensing aperture formed therein and a sealing flange extending up from the top of the lid bottom and encompassing the dispensing aperture;
a lid top having a top surface, a bottom surface, a front edge portion, a rear edge portion and a sealing flange extending down from the bottom of the lid top and configured to mate with the sealing flange of the lid bottom a hinge integrally formed with and connecting the rear edge portions of the lid bottom and the lid top, the hinge comprising a first piece having a surface disposed at a first angle and secured to the lid top and a second piece having a second surface disposed at a second angle secured to the lid bottom, wherein the second angle is larger than the first angle and wherein the first and second surfaces fit together under pressure when the lid is in the closed position; and
a push button flexibly secured and integrally formed with the front edge portion of the lid bottom, the push button including a latching portion configured to engage the front edge portion of the lid top.
